(19) United States
(12) Patent Application Publication
(10) Pub. No.: US 2025/0054106 A1
(43) Pub. Date: Feb. 13, 2025

(54) MACHINE VISION SYSTEM FOR THE AUTOMATED IDENTIFICATION OF FIDUCIAL TAGS IN REAL-WORLD IMAGES BASED ON SIMULATED TRAINING DATA

(71) Applicant: Pig Improvement Company UK Limited, Basingstoke, Hampshire (GB)

(72) Inventors: Eric Psota, Lincoln, NE (US); William Herring, Gallatin, TN (US); Robert Fitzgerald, Lafayette, TN (US)

(73) Assignee: Pig Improvement Company UK Limited, Basingstoke, Hampshire (GB)

(21) Appl. No.: 18/722,245

(22) PCT Filed: Dec. 19, 2022
(86) PCT No.: PCT/GB2022/053291

§ 371 Date: Jun. 20, 2024

Related U.S. Application Data
(60) Provisional application No. 63/265,775, filed on Dec. 20, 2021.

(51) Int. Cl. G06T 5/50

(52) U.S. Cl. CPC G06T 5/50; G06T 2207/20081; G06T 2207/20084; G06T 2207/20221

(57) ABSTRACT

The present invention relates to the training of a convolutional neural network by a set of automatically generated simulated training data for use in a machine vision system for identifying fiducial tags associated with entities. Four-character fiducial tags are randomly generated or selected and then randomly transformed and superimposed on images to generate a set of simulated training data to be fed into a convolutional neural network to train the network model. The trained convolutional neural network is used to identify fiducial tags disposed on entities in real-world images and video.

### FIELD OF THE INVENTION

The present invention relates to the fields of artificial intelligence, machine learning, and machine vision. More specifically, the present invention relates to the field of automatic fiducial identification in video or image data and to the field of the automated training of a machine vision system by automatically generated, simulated training data.

### BACKGROUND

Manual, large-scale phenotyping of animal behavior traits in a manual manner by human observers is time consuming and subjective. However, existing methods for the automated tracking of animals has only seen limited testing in controlled environments and may require the use of expensive or complicated equipment to implement. Additionally, recording from animals in large groups in highly variable farm settings presents challenges.

In some animal husbandry applications, such as on commercial farms, in breeding operations, genetic nucleus farms, and in multiplier farming operations, the use of cameras to automate the recording of behavior has already been applied to species that are easy to manage in highly-controlled settings, for example movement tracking of color-labelled laboratory rodents in small groups indoors under constant artificial light in standardized caging. Commercial farm conditions offer several challenges including group sizes and stocking density, unmarked individuals, variable lighting and background, and the possibility that the animal becomes soiled with dirt or feces. One of the current key knowledge gaps is how to track individual animals in a pen and record their behavior while continuously recognizing the individual.

In addition to animal behavior, information streams which may be utilized in a commercial farming operation may include sensors which provide information about the farm environment or building control systems such as meteorological information, temperature, ventilation, the flow of water or feed, and the rate of production of eggs or milk. With the development of the Internet of Things (“IoT”), it may be desirable to connect disparate data streams and to combine those data streams with non-subjective assessments of phenotypic traits or physical/anatomical conditions for animals to provide for the optimum outcome for the animals and for a commercial farming operation.

With respect to machine learning and machine vision systems, existing systems and methods are generally focused on tracking individuals, such a people, over a period of minutes and are prone to errors. Existing systems are not suited to situations demanding high accuracy or for tracking entities over a longer period of time (e.g., weeks, months, or years). Fiducials and fiducial-based tracking systems such as, but not limited to, ARTOOLKIT, ARTAG, RUNETAG, REACTIVISION, BULLSEYE, FOURIERTAG, CALTAG, APRILTAG, and CHROMATAG, have been used in an attempt to address some of these issues. However, these solutions suffer from drawbacks such as not being human readable, not conforming to a standard printing or form factor, and not being designed for environments where the fiducial may become dirty, damaged, distorted, blurred, or otherwise obscured.

Additionally, traditional methods for training machine vision are labor intensive and expensive. Typically, to train a machine vision system a number of images to comprise a training image set are manually gathered, collected, or curated, or a suitable set of images is selected, and then the images are manually annotated by a human user. There may be tens, hundreds, or thousands of possible tags or annotations that need to be made on each image in a training image set, and these tags or annotations may comprise an incredibly large number of possible combinations. This presents a significant in preparing a training data set for a machine learning system, and in implementing a training pipeline or regime for the machine learning system because of the significant time and complexity involved in selecting, annotating, or otherwise preparing the training data and in implementing the training data set.

What is needed is an automated computer-vision system capable of identifying of identifying individual animals from an image based on a fiducial associated with the animal. What is needed is a fiducial that is readable by both a human operator and by an automated computer-vision system. What is needed is a fiducial that is suitable for use in an environment wherein the fiducial may become dirty, damaged, distorted, blurred, or otherwise obscured. What is needed is a system and method for automatically training a machine vision system. What is needed are systems, methods, and software to address these and other related problems.

### SUMMARY OF THE INVENTION

What is provided are systems, methods, and software for training a machine vision system using automated machine learning by an automatically generated, simulated training data set. In the training data set, actual or artificially generated fiducials are generated and randomly skewed, modified, distorted, obfuscated, or otherwise altered and then superimposed on randomly selected images from an image data set.

What is provided are systems and methods for tracking an individual entity or multiple individual entities, such as animals, in a space based on image or video data by a fiducial that is both machine and human readable. The fiducial comprises images or characters which are recognizable both by human operators and by a machine vision system, and the fiducial is affixed, attached, or otherwise disposed on an associated entity.

What is provided is a system, method, and computer software for the training of a convolutional neural network by a set of automatically generated simulated training data for use in a machine vision system for identifying fiducial tags associated with entities. Four-character fiducial tags are randomly generated or selected and then randomly transformed and superimposed on images to generate a set of simulated training data to be fed into a convolutional neural network to train the network model. The trained convolutional neural network is used to identify fiducial tags disposed on entities in real-world images and video.

Provided herein are systems and methods for automatically monitoring one or more animals to derive a phenotype for each of the monitored animals. Animals, such as livestock (e.g., cows, goats, sheep, pigs, horses, llamas, alpacas), may be housed in animal retaining spaces such as pens or stalls that may be disposed within covered structures such as barns. The systems and methods may comprise capturing images or video of animals, such as side-views or from top-down views, while the animals are disposed in the animal retaining spaces or walkways within a barn or other structure. The images may then be stored in a networked video storage system that is in electronic communication with the image sensor, such as a camera, webcam, or other suitable image sensor, located at or near the animal retaining spaces.

In one embodiment, what is provided is a method of training a machine vision system comprising a convolutional neural network, the method comprising: generating or selecting a set of fiducial tags; generating a set of transformed fiducial tags by randomly transforming each fiducial tag from the set of fiducial tags; generating a set of superimposed training images by superimposing each transformed fiducial tag from the set of transformed fiducial tags on a random image from a set of images; and training the convolutional neural network by processing each superimposed training image in the set of superimposed training images.

In an embodiment of the method, the set of fiducial tags comprise four-character tags.

In an embodiment of the method, the convolutional neural network comprises a DenseNet convolutional neural network.

In an embodiment of the method, the DenseNet convolutional neural network comprises five Dense Blocks and one linearization block.

In an embodiment of the method, the linearization block comprises four convolutions used on a single feature volume to extract four probability vectors, one for each of the four characters of the fiducial tags.

In one embodiment, what is provided is a system for identifying a fiducial associated with an entity, the system comprising: a set of fiducial tags, each fiducial tag from the set of fiducial tags associated with an entity from a set of entities; an image sensor configured to digital capture images of the entity and the fiducial associated with the entity; and an application server in electronic communication with the image sensor, the application server comprising: a processor and a memory; a machine learning module; an image processing module; and a fiducial identification module.

In an embodiment of the system, the machine learning module comprises a set of code stored in the memory and when executed by the processor cause the machine learning module to: generate or select a set of simulated fiducial tags; generate a set of transformed fiducial tags by randomly transforming each fiducial tag from the set of simulated fiducial tags; generate a set of superimposed training images by superimposing each transformed fiducial tag from the set of transformed fiducial tags on a random image from a set of images; and train a convolutional neural network by processing each superimposed training image in the set of superimposed training images.

In an embodiment of the system, the fiducial identification module comprises a convolutional neural network configured to identify the set of fiducial tags associated with the set of entities.

In an embodiment of the system, the set of fiducial tags comprise four-character tags.

In an embodiment of the system, the convolutional neural network comprises a DenseNet convolutional neural network.

In an embodiment of the system, the DenseNet convolutional neural network comprises five Dense Blocks and one linearization block.

In an embodiment of the system, the linearization block comprises four convolutions used on a single feature volume to extract four probability vectors, one for each of the four characters of the fiducial tags.

In an embodiment of the system, the processor is a graphics processing unit.

In one embodiment, what is provided is a method of training a machine vision system comprising a convolutional neural network, the method comprising: generating or selecting a set of fiducial tags; generating a set of transformed fiducial tags by randomly transforming each fiducial tag from the set of fiducial tags; generating a set of superimposed training images by superimposing each transformed fiducial tag from the set of transformed fiducial tags on a random image from a set of images; and training the convolutional neural network by processing each superimposed training image in the set of superimposed training images.

In various embodiments, the set of fiducial tags comprise four-character tags, six-character tags, eight-character tags, or ten-character tags.

In various embodiments, a subset of characters on each of the set of fiducial tags comprises error-control coding.

In various embodiments, the error-control coding comprises Reed-Solomon encoding.

In various embodiments, the convolutional neural network comprises a DenseNet convolutional neural network.

In various embodiments, the DenseNet convolutional neural network comprises five Dense Blocks and one linearization block.

In various embodiments, the linearization block comprises four convolutions used on a single feature volume to extract four probability vectors, one for each of the four characters of the fiducial tags.

In various embodiments, training the convolutional neural network further comprises training the convolutional neural network to identify a set of characters on a physical tag.

In various embodiments, the method further comprises associating the set of characters on the physical tag with an entity.

In various embodiments, the entity is a porcine or bovine animal.

In one embodiment, what is provided is a system for identifying a fiducial associated with an entity, the system comprising: a set of fiducial tags, wherein each fiducial tag from the set of fiducial tags is associated with an entity from a set of entities; an image sensor configured to digital capture images of the entity and the fiducial associated with the entity; and an application server in electronic communication with the image sensor, the application server comprising: a processor and a memory; a machine learning module; an image processing module; and a fiducial identification module.

In various embodiments, the machine learning module comprises a set of code stored in the memory and when executed by the processor cause the machine learning module to: generate or select a set of simulated fiducial tags; generate a set of transformed fiducial tags by randomly transforming each fiducial tag from the set of simulated fiducial tags; generate a set of superimposed training images by superimposing each transformed fiducial tag from the set of transformed fiducial tags on a random image from a set of images; and train a convolutional neural network by processing each superimposed training image in the set of superimposed training images.

In various embodiments, the fiducial identification module comprises a convolutional neural network configured to identify the set of fiducial tags associated with the set of entities.

In various embodiments, the system further comprises: an entity identification module; and wherein the entity identification module comprises a set of code stored in the memory and when executed by the processor cause the entity identification module to: associate a set of characters on the fiducial tag with an entity.

In various embodiments, the entity is a porcine or bovine animal.

In various embodiments, the set of fiducial tags comprise four-character tags, six-character tags, eight-character tags, or ten-character tags.

In various embodiments, a subset of characters on each of the set of fiducial tags comprises error-control coding.

In various embodiments, the error-control coding comprises Reed-Solomon encoding.

In various embodiments, the convolutional neural network comprises a DenseNet convolutional neural network.

In various embodiments, the DenseNet convolutional neural network comprises five Dense Blocks and one linearization block.

In various embodiments, the linearization block comprises four convolutions used on a single feature volume to extract four probability vectors, one for each of the four characters of the fiducial tags.

In various embodiments, the processor is a graphics processing unit.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention but are intended to be exemplary and for reference.

FIG. 1 provides a block diagram of a machine vision system according to one embodiment.

FIG. 2 provides an illustration of a machine vision system according to one embodiment.

FIG. 3 provides a flow chart of a process for training a machine vision system according to one embodiment.

FIG. 4 provides a flow chart of a process for identifying fiducials within an image or video using a machine vision system according to one embodiment.

FIG. 5 provides a representation of fiducial tags used with a machine vision system according to one embodiment.

FIG. 6 provides a diagram of a process for automatically generating a set of simulated training data according to one embodiment.

FIG. 7 provides a diagram of a model for a DenseNet convolutional neural network for use in a machine vision system according to one embodiment.

FIG. 8 provides a diagram of a set of characters used in fiducials for a machine vision system according to one embodiment.

FIG. 9 provides a diagram of a set of simulated training images, a set of characters in fiducials in the training images, a set of fiducials identified by a machine vision system from a set of training images, and a set of outputs determined by the machine vision system from the set of identified fiducials according to one embodiment.

FIG. 10 provides a diagram of a set of images comprising fiducial tags identified in real-world images or video by a machine vision system trained using simulated training data according to one embodiment.

FIG. 11 provides a diagram of an output of a machine vision system training using simulated training data wherein the output comprises an annotated output image and a data summary of all entities identified in the annotated output image.

FIG. 12 provides a diagram of a set of simulated training images according to one embodiment.

FIG. 13 provides a diagram of an output of a machine vision system training using simulated training data wherein the output comprises an annotated output image.

FIG. 14 provides a diagram of a set of images comprising fiducial tags mis-identified in real-world images or video by a machine vision system trained using simulated training data according to one embodiment.

FIG. 15 provides a diagram of an exemplary 8 character design of fiducial tag.

FIG. 16 provides a diagram of a fiducial tag including non-alphanumeric characters for error correction.

### DETAILED DESCRIPTION

The systems and methods herein will now be described in more detail with reference to exemplary embodiments as shown in the accompanying drawings. While the present invention is described herein with reference to the exemplary embodiments, it should be understood that the systems and methods herein are not limited to such exemplary embodiments. Those possessing ordinary skill in the art and having access to the teachings herein will recognize additional implementations, modifications, and embodiments, as well as other applications for use of the invention, which are fully contemplated herein as within the scope of the systems and methods as disclosed and claimed herein, and with respect to which the systems and methods herein could be of significant utility.

As used herein, “entity” or “entities” are any thing or things being monitored or tracked. For example, an entity may be, without limitation, a person, an animal such as a porcine or bovine animal, a vehicle, a product, a structure, or other physical item which may be identified or tracked.

As used herein, a “fiducial” is an object or marker placed in the field of view of an imaging system or image sensor that appears in the image produced or in the image or video captured by the system or sensor, for use as a point of reference, a measure, or as a means of identification of an entity. A fiducial may be either something placed into or on the imaging subject or entity, or a mark or set of marks in the reticle or field of view of an optical instrument or sensor. Without limitation a fiducial may be a shape, character, symbol, or numeral.

As used herein, a “machine vision system” is a computer-based system implemented in any combination of hardware, software, or firmware and which may comprise one or more computing devices at one or more locations and which is configured or programmed to process images or video captured by an image sensor, such as a camera, to identify and/or track things, such as entities, within the images or video.

As used herein, a “simulated training data” is training or input data for a machine learning process or neural network which comprises images automatically or semi-automatically generated by a computer system or software and which comprise images other than unmodified real-world images. Simulated training data is data or a set of data which is configured or designed to train or configure a machine learning system or model, such as a neural network, to provide for the processing of non-training data.

As used herein, “superimposed” means a first thing or things placed, positioned, or disposed on a second thing, such as a first image placed in, on, or over a second image, such that the first thing is fully or partially visible when placed on the second thing, and such that the second thing is not fully obscured or covered by the first thing.

As used herein, a “tag” is an object or marker which is placed upon another thing and which is used as a means of identification of the thing.

As used herein, a “transformation” is a modification, effect, or change of an image or of a portion of an image such as changing characters within an image, shifting characters within an image, adding noise to an image, changing image contrast, adding a blur effect to an image, sharpening an image, adding black or white point to an image, shadowing an image by multiplying an image with a separate random image, skewing an image, changing the brightness or gamma of an image, distorting or warping an image, obfuscation of a portion or entirety of an image, or any combination of these or other image modification effects.

As used herein, a “fiducial tag” is a tag which comprises or contains one or more fiducials.

As used herein, “human readable” or “human interpretable” means something which is capable of being identified, processed and understood independently by a human without assistance from additional machine or computer devices or systems.

As used herein, a “physical tag” is an identification apparatus or thing that is placed on, disposed on, or otherwise affixed to an entity. For example, an example of a physical tag may be an ear tag, a collar, a collar tag, or an ankle or leg tag. A physical tag may comprise one or more fiducials and a physical tag may be a fiducial tag.

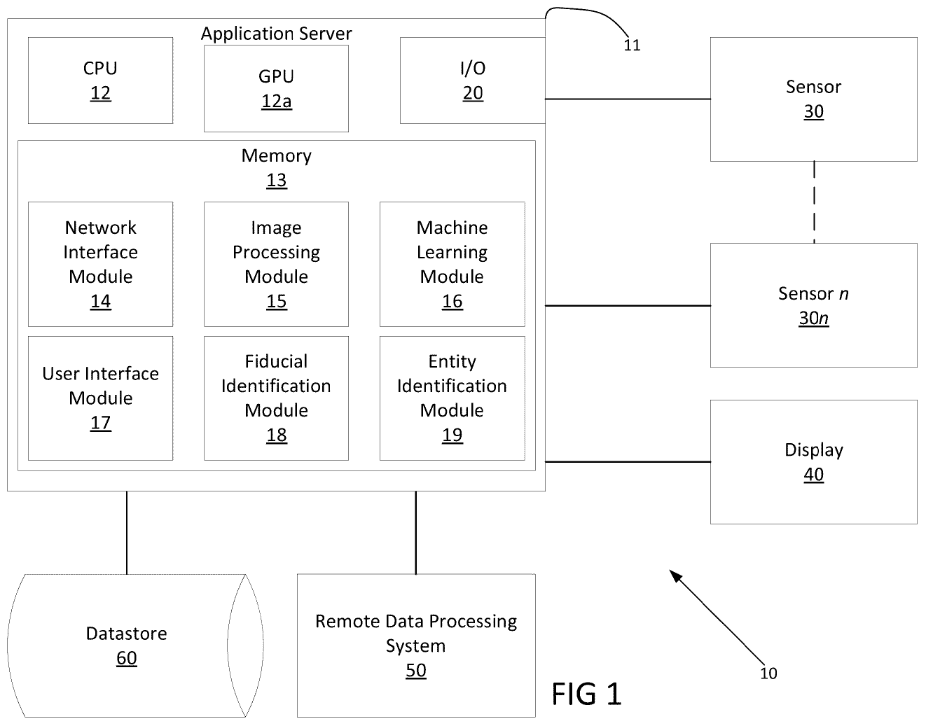

Now, with respect to FIG. 1, a block diagram of a system 10 for identifying a fiducial tag based on information collected by one or more sensors 30 and processed by an image processing module 15 according to one embodiment is provided. The system 10 comprises an application server 11, a set of sensors 30 to 30n, a display 40, a remote data processing system 50, and a datastore 60. The application server 11 is a specially-configured computer system comprising a CPU 12, a GPU 12a, an input/output (“I/O”) interface 20, and a memory 13. A set of specially configured modules are stored in the memory 13, which may be a non-transitory computer readable media. The modules comprise a network interface module 14, an image processing module 15, a machine learning module 16, a user interface module 17, a fiducial identification module 18, and an entity identification module 19. The identified modules may be separate modules configured to, when executed, cause the CPU 12 or GPU 12a to perform specific functions, and may be separate modules or may have their functionality shared or combined in varying embodiments.

The sensors 30 through 30n comprise a set of sensors connected to the application server 11 through electronic communications means, such as by Ethernet or BLUETOOTH connections. The sensors 30 through 30n may comprise sensors such as image sensors (e.g., electronic video cameras, CMOS image sensors, or CCD cameras), RFID readers, pressure sensors, weight sensors, or proximity sensors. In an exemplary embodiment the set of sensors 30 through 30n comprises at least one video camera, or one or more video cameras. The I/O module 20 receives communications or signals from the sensors 30 through 30n where they may be directed to the appropriate module within the application server 11.

The datastore 60 is a remote database or data storage location, such as an NVR, where data may be stored. In one embodiment, one or more of the sensors 30 through 30n are in direct communication with the datastore 60. The datastore 60 may be a remote database or data storage service such as a cloud storage provider that may be used to store and manage large volumes of data, such as images, video, phenotype predictions, or other information collected or processed by the system 10.

The remote data processing system 50 may share or comprise some or all of the functions of the application server 11, thereby offloading some or all of the functions to a more suitable location where necessary. For example, some functions may be too processor or computationally intensive or expensive to be co-located with an animal retaining space, such as at a commercial farm. In these circumstances, it may be desirable to move some or all of the more computationally expensive or intensive activities off-site to be performed by the remote data processing system 50, which may be owned and operated by the user of the application server 11, or may be owned and operated by a third-party services provider.

With respect to the modules of the application server 11, the network interface module 14 provides for the handling of communication between the sensors 30 through 30n, the datastore 60, the remote data processing system 50, and the application server 11, such as through Ethernet, WAN, BLUETOOTH, or other wired or wireless radio telecommunications protocols or methods. The network interface module 14 may handle the scheduling and routing of network communications within the application server 11. The user interface module 17 provides for the generation of a GUI which may display predicted phenotypic information or health predictions or outcomes. Other information processed or stored in the server 11, or remotely accessible via the datastore 60 or remote data processing system 50, may also be presented to a user via a GUI generated by the user interface module 17. The user interface module may be used to generate locally viewable or web-based GUIs which may be used to view information on the application server 11 or to configure the parameters of the any system module.

The image processing module 15, which may be a module configured to provide for computer-based and GPU driven machine vision, comprises a deep learning or convolutional neural network that is trained and configured as described herein. The machine learning module 16 provides for the input and configuration of training data that is used to train and establish the deep learning or convolutional neural network implemented by the image processing module 15. The image processing module 15 is configured to receive as input one or more images, image frames, or video data, such as data stored in the datastore 60, to process the images such that the fiducial identification module 18 from the image data processed by the image processing module 15. For example, image data captured and stored as described herein may be fed into the trained convolutional neural network as input, and one or more fiducials may be identified from the input image data by the convolutional neural network. The fiducial identification module 18 may then identify one or more fiducials and associated entities, such as animals, based on output of the image processing module 15. The output of the fiducial identification module 18 may then be used by the entity identification module 19 to identify an entity associated with an identified fiducial. For example, the entity identification module 19 may identify certain features, such as anatomical features of an animal, based in part upon the output of the fiducial identification module 18.

The display 40 is in electronic communication with the application server 11 and may provide for the viewing of a GUI displaying identified fiducials and associated entity locations. Other information processed or stored in the server 11, or remotely accessible via the datastore 60 or remote data processing system 50, may also be presented to a user via a GUI in the display 40. In some embodiments, the display 40 is associated with a separate computer or computing device, such as a smartphone, tablet, laptop, or desktop computer which is used by a user to remotely view and access the application server 11.

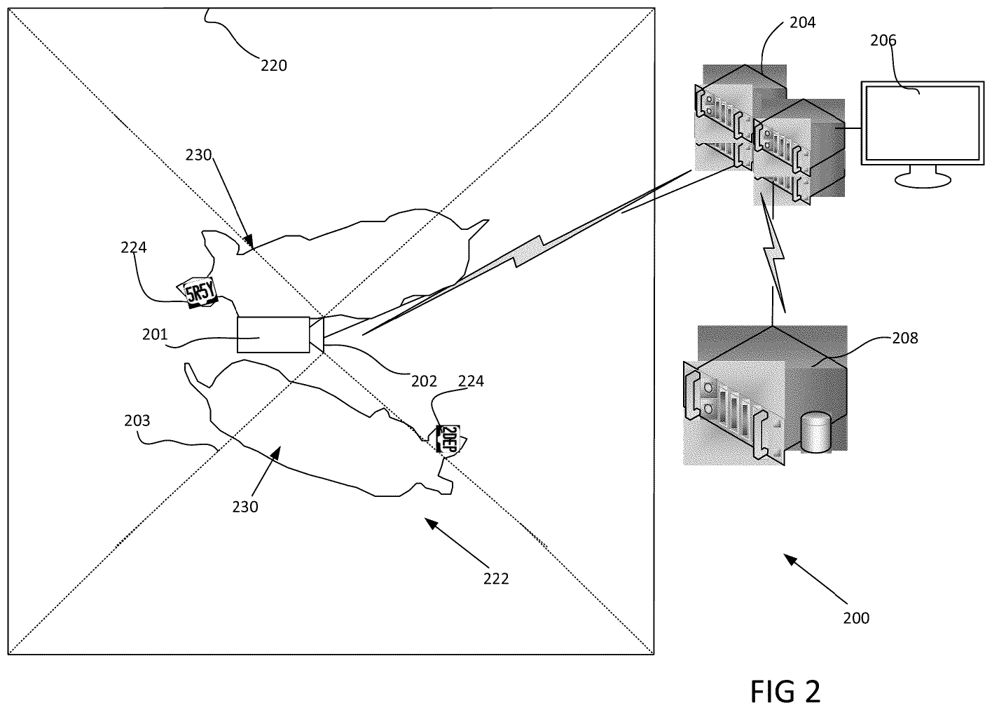

With reference now to FIG. 2, a diagram representing a machine vision system 200 is provided. The system 200 comprises an image capture device 201, such as an electronic camera, CMOS camera, or CCD camera, having a lens 202, an application server 204, a display 206 and a remote server 208. The image sensor 201 is electronic communication, such as wired via Ethernet or wireless by a wireless radio communication link such as BLUETOOTH, with the application server 204, which is in electronic communication, such as by local area network or wide area network (e.g., Internet), with the remote server 208.

The application server 204 may be one or more special purpose computing devices, such as an NVR and an image processing server comprising a GPU, and in some embodiments the functionality of the application server 204 may be distributed among a plurality of local machines and/or to the remote server 208, which may be one or more computing devices, or may be a cloud computing or storage solution or service.

The image sensor 201 is positioned such that the field of view 203 of the lens 202 is pointed or directed towards an animal retaining space 220 (e.g., a pen) where one or more animals 230 are disposed. The retaining space 220 may be defined by a plurality of enclosing walls, which may have one or more openings, gates, or doors, and by a supporting floor or surface, and which may have an open or unenclosed top.

In operation, when the animals 230 are positioned in the animal retaining space 220, images or video of the animals 230 are captured by the image sensor 201 and transmitted to the application server 204.

At the application server 204, which may be co-located in the same facility as the image sensor 201 and animals 230, or may be located in a remote facility, the images are processed by a convolutional neural network to identify at least one fiducial 224 in each image frame. The at least one fiducial 224 may be used with additional machine vision processing, such as by the entity identification module 19, to identify an entity, such as an animal like a swine, associated with the identified fiducial 224. In some embodiments, the images captured and used as input for a convolutional neural network may be color images, black and white images, depth images, 2-D images, 3-D images, or thermal images captured by a correspondingly suited image sensor device.

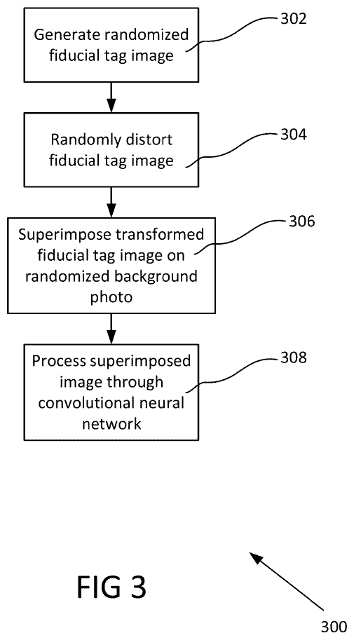

With reference now to FIGS. 3, 5, 6, 7, 8, and 9, an embodiment of a system and method for training a convolutional neural network-based machine vision system by a set of simulated training data, and a system and method for automatically generating the set of simulated training data are provided.

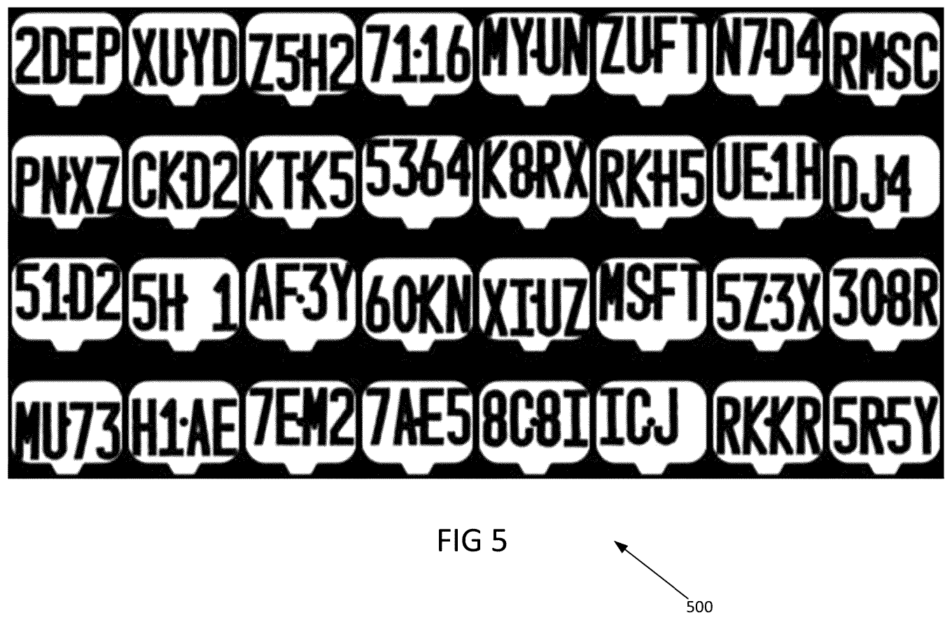

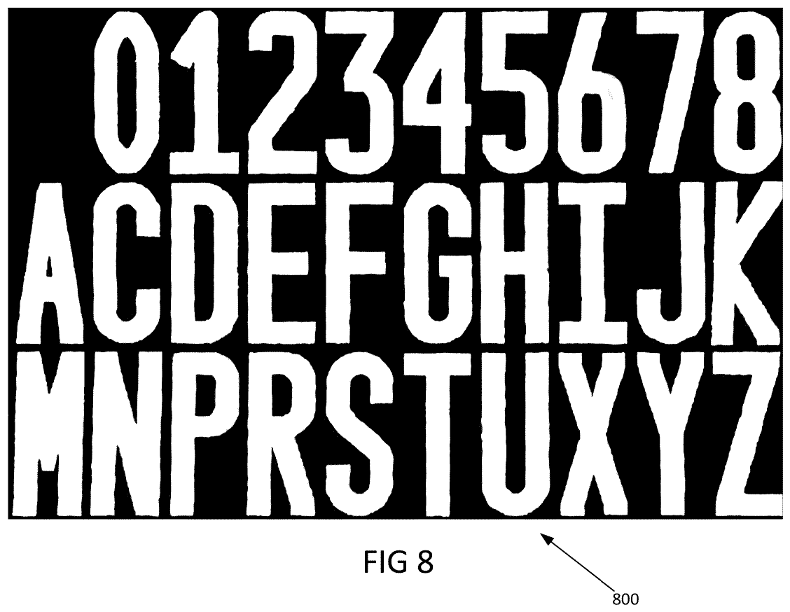

FIG. 3 provides a flow chart of a process 300 for training a machine vision system using simulated training data. In step 302, a randomized fiducial tag or image is generated, or a pre-generated fiducial tag or image is selected. For example, the fiducial tag used in step 302 may be one of the fiducial tags 500 illustrated in FIG. 5. The fiducial tags 500 in FIG. 5 are a non-limiting example and comprise a set of four-digit or four-character HOGMAX ear tags. The fiducial tags 500 shown in FIG. 5 comprise one, two, three, or four-digits or characters from the set of characters 800 shown in FIG. 8. The set of characters 800 in FIG. 8 comprise a set of thirty (30) characters which avoids ambiguous characters which may decrease the confidence of the machine vision system in any character identified in a fiducial. For example, the set of thirty characters in the set of characters 800 used in the exemplary set of fiducials 500 uses the character 6 instead of 6 and 9, uses the character 8 instead of 8 and B, uses the character 7 instead of 7 and L, uses the character 0 (zero) instead of the characters 0 O and Q, uses the character A instead of A and V, and uses the character M instead of M and W. However, while the fiducial tags 500 comprise a truncate set of non-ambiguous characters 800, any other suitable fiducials may be used so long as the fiducials are fully human-readable (i.e, do not comprise fully abstract shapes or patterns) and are compatible with a machine vision system and are readable by the machine vision system when dirty, damaged, or partially obscured, blurred, distorted, or obfuscated. By way of example, fiducials which employ easily discernable geometric shapes (e.g., square, triangle, circle, etc.) and/or colors (e.g., black, white, red, yellow, blue) may be used so long as the fiducials are readily interpretable by both human operators and by the machine vision system. For example, in one embodiment a fiducial tag is automatically generated by selecting one, two, three or four characters from the set of characters 800 and placing the selected characters into a shape representing a tag, such as the shape of one of the fiducial tags 500. In one embodiment, a fiducial tag or fiducial tag to be used in later steps, such as step 304, 306, and 308, is randomly selected from a set or library of pre-generated fiducial tags.

In step 304, each of the generated or selected fiducial tags from step 302 are randomly transformed by the system. For example, fiducial tags such as fiducial tags 500 may be transformed by changing characters within a tag, shifting characters within a tag, adding noise to a tag, changing image contrast for a tag, adding a blur effect to a tag, sharpening an image of a tag, adding black or white point to a tag, shadowing a tag by multiplying the tag with a separate random image, skewing a tag, changing the brightness or gamma of a tag, distorting or warping a tag, obfuscating a portion or entirety of a tag, or any combination of these or other image modification effects may be used. The transformation effects in step 304 are randomly selected and applied to a fiducial tag. The transformation effects may be used more than once and may be used in combination with other transformation effects. The transformation may be applied to contents of a tag, such as the fiducial characters, or may be applied to the tag shape itself. For example, in one embodiment the fiducial tags may be transformed by warping using an affine warping function applied by using the “warp( )” function within MATLAB. In one embodiment, the fiducial tags may be transformed by sharpening, radial blurring, or motion blurring using a filter function applied by using the “imfilter( )” function within MATLAB. In one embodiment, functions and features of the MATLAB image processing toolbox may be used to transform the fiducials, fiducial tags, or fiducial tag images. In one embodiment, a single transformation step is randomly applied to a fiducial tag. In one embodiment, multiple transformation steps are randomly applied to a fiducial tag.

In step 306, each of the transformed fiducial tags from step 304 is superimposed on a randomly selected background image or photo. For example, a background image from a background image set is selected at random, and then a transformed fiducial image from the set of transformed fiducial images is placed randomly on the background image. In one embodiment, the background image is randomly sampled from the 2017 COCO image validation set which comprises 5000 images. Prior to the transformed image tag being superimposed on the background image, the background image is downscaled to a size of 65×65 pixels, converted to a grayscale image, and is randomly flipped and rotated, which may comprise no flips or rotations. To superimpose the image of the fiducial tag on the background image the tag shape is used to mask out a portion of the background image and is inserted additively into the background image. The location for the transformed tag image to be superimposed is selected by randomly sampling all pixel locations within the background image, wherein pixel locations near the border of the background image are excluded from the sampling. The randomly selected location for the superimposition of the fiducial tag image on the background image is selected automatically by the system to ensure that the resulting transformed, superimposed fiducial tag is fully visible in the composite (superimposed) image and to ensure that the transformed, superimposed fiducial tag does not extend beyond the bounds of the background image. The output of step 306 is a set of simulated training data or images which may be used in a machine vision system to train the system to recognize fiducial tags in real world images or video. However, other background image sets, methods of selecting a location for superimposition, and for superimposing the transformed fiducial tag image may be used.

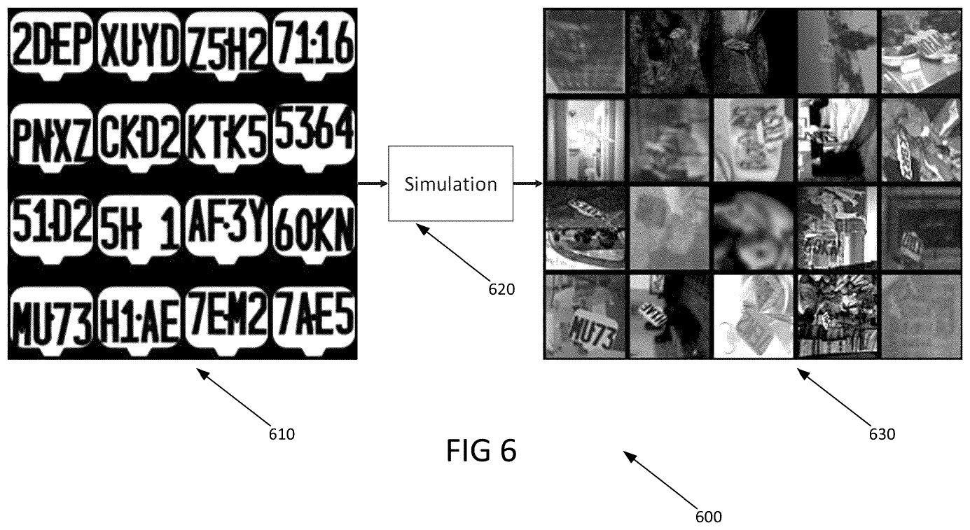

In one embodiment, the simulated training data process 600 provided in FIG. 6 is illustrative of the steps 302, 304, and 306 shown in FIG. 3. For example, the set of fiducial tags 610 comprises a set of images of fiducial tags which may have been generated in the step 302. The simulation process 620 may comprise the processes and systems of steps 304 and 306, and the output of the simulation process 620 is the set of simulated training images 630. The set of simulated training images 630 comprises a set of randomly selected background images, which have been processed or modified, each with one or no (zero) transformed fiducial tag images superimposed thereon.

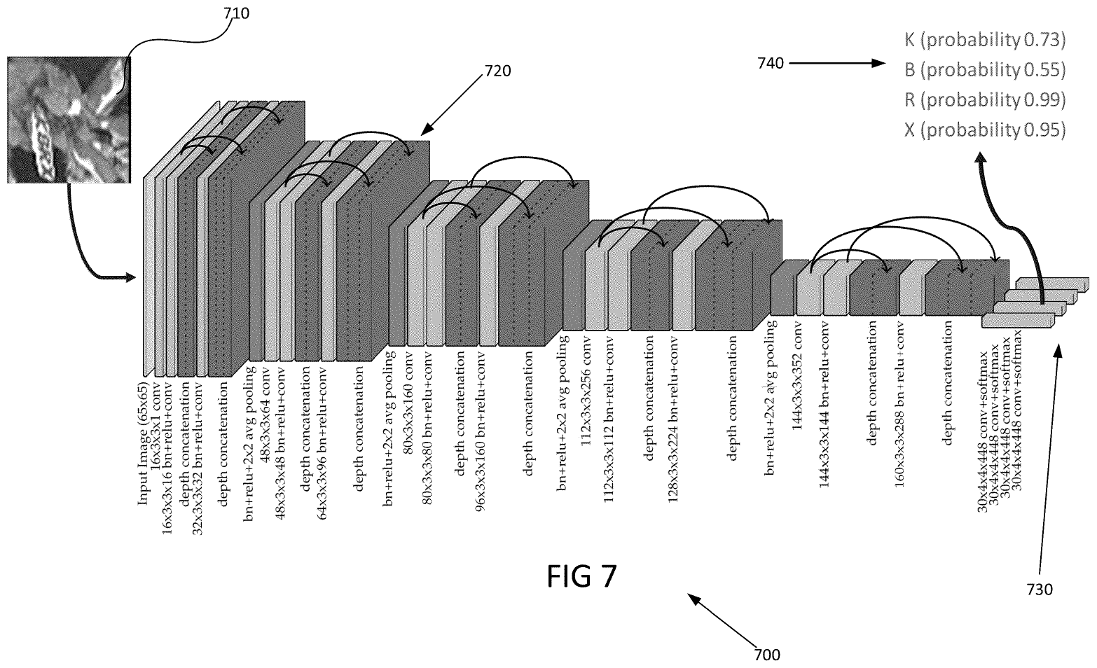

In step 308, the set of simulated training data or images comprising the set of transformed fiducial tags superimposed on randomly selected background images is used as input or training data to train a machine vision system. The set of simulated training data is fed into a neural network. In one embodiment, the neural network is a DenseNet convolutional neural network (“CNN”). The DenseNet CNN is described in Huang, G., Liu, Z., Van Der Maaten, L., & Weinberger, K. Q. (2017); Densely connected convolutional networks; In Proceedings of the IEEE conference on computer vision and pattern recognition (pp. 4700-4708); which is incorporated by reference herein in its entirety. In one embodiment, a set of tools is used to generate a parameterized DenseNet CNN in MATLAB. A DenseNet CNN is well-suited to image processing and object identification within an image. A DenseNet CNN is efficient in using limited input parameters and is not as susceptible to overfitting as other CNN types. In one embodiment, the DenseNet CNN 700 used comprises the following processes broken down by “Dense Blocks” 720 as illustrated in FIG. 7.

In the embodiment shown in FIG. 7, an input image 710 from the simulated training data set is selected or obtained and fed into Dense Block 1, which is one of five of the Dense Blocks 720.

### Dense Block 1:

1) 16×3×3×1 convolution (“conv”)
2) 16×3×3×16 batch normalization (“bn”)+rectified linear activation unit (“ReLU”)+conv
3) depth concatenation×2
4) 32×3×3×32 bn+ReLU+conv
5) depth concatenation×3

### Dense Block 2:

1) bn+ReLU+2×2 average pooling
2) 48×3×3×64 conv
3) 43×3×3×48 bn+ReLU+conv
4) depth concatenation×2
5) 64×3×3×96 bn+ReLU+conv

### Dense Block 3:

1) bn+ReLU+2×2 average pooling
2) 80×3×3×160 conv
3) 80×3×3×80 bn+ReLU+conv
4) depth concatenation×2
5) 96×3×3×160 bn+ReLU+conv

### Dense Block 4:

1) bn+ReLU+2×2 average pooling
2) 112×3×3×256 conv
3) 112×3×3×112 bn+ReLU+conv
4) depth concatenation×2
5) 128×3×3×224 bn+ReLU+conv

### Dense Block 5:

1) bn+ReLU+2×2 average pooling
2) 144×3×3×352 conv
3) 144×3×3×144 bn+ReLU+conv
4) depth concatenation×2
5) 160×3×3×288 bn+ReLU+conv

### Pooling and Linearization Block 730:

1) four parallel processes of 30×4×4×448 conv+SoftMax processing, one for each of the four characters in the fiducial tag.

Generally, each Dense Block 720 comprises a pooling, two convolutions, a first depth concatenation, a third convolution, and a second depth concatenation, with the exception of the first Dense Block 720, which does not have an initial pooling step and which instead comprises an input image first step. The order of the steps for convolution, concatenation, and pooling may be selected, configured, and modified as described in He, K., Zhang, X., Ren, S., & Sun, J. (2016); Deep residual learning for image recognition; In Proceedings of the IEEE conference on computer vision and pattern recognition (pp. 770-778); which is incorporated by reference herein in its entirety. However, the specific steps and configuration of the DenseNet 700 shown in the embodiment of FIG. 7 were selected to provide a DenseNet that would be able to identify each character or element of a fiducial tag without overfitting and while being able to make use of limited input parameters.

For the output in block 730, four convolutions are used on the same feature volume to extract the probability vectors for each character in the fiducial tag. In the example shown in FIG. 7, the output 740 shows a probability of 0.73 for “K” being the first character in the fiducial tag in the input image 710, a probability of 0.55 for “B” being the second character, a probability of 0.99 for “R” being the third character, and a probability of 0.95 for “X” being the fourth character.

The DenseNet 700 identifies characters within fiducial tags at an accuracy of 35% for 4 of 4 characters, 44.7% for 3 of 4 characters, and 52.4% for 2 of 4 characters, and for four-character tags from a set of 30 characters can be used to identify from a total of 810,000 possible tags. In one embodiment, the DenseNet 700 is implemented in MATLAB and is executed using an NVIDIA graphics card such as an NVIDIA GTX or RTX graphics card, which may be, for example an NVIDIA RTX 3080. Using an NVIDIA RTX 3080 (e.g., as the GPU 12a shown in FIG. 1) the DenseNet 700 can be used to read fiducial tags at a rate in excess of 4000 tag reads per second.

A single DenseNet configured as described herein and trained using simulated training data as described herein provides unexpected computer system performance and accuracy advantages beyond using separate systems for the transformation and classification of fiducial tags. For example, in other experiments, the inventors found that training two networks, one for the transformation of the fiducial tag within the image and one for the classification of the fiducial tag after the transformations had been undone performed worse than a single, combined system. The separate systems performed worse and took significantly longer to classify tags than a single, small DenseNet CNN. Additionally, the DenseNet configured as described herein and trained using simulated training data as described herein performs orders of magnitude faster, and more accurately, than a human-operator based system.

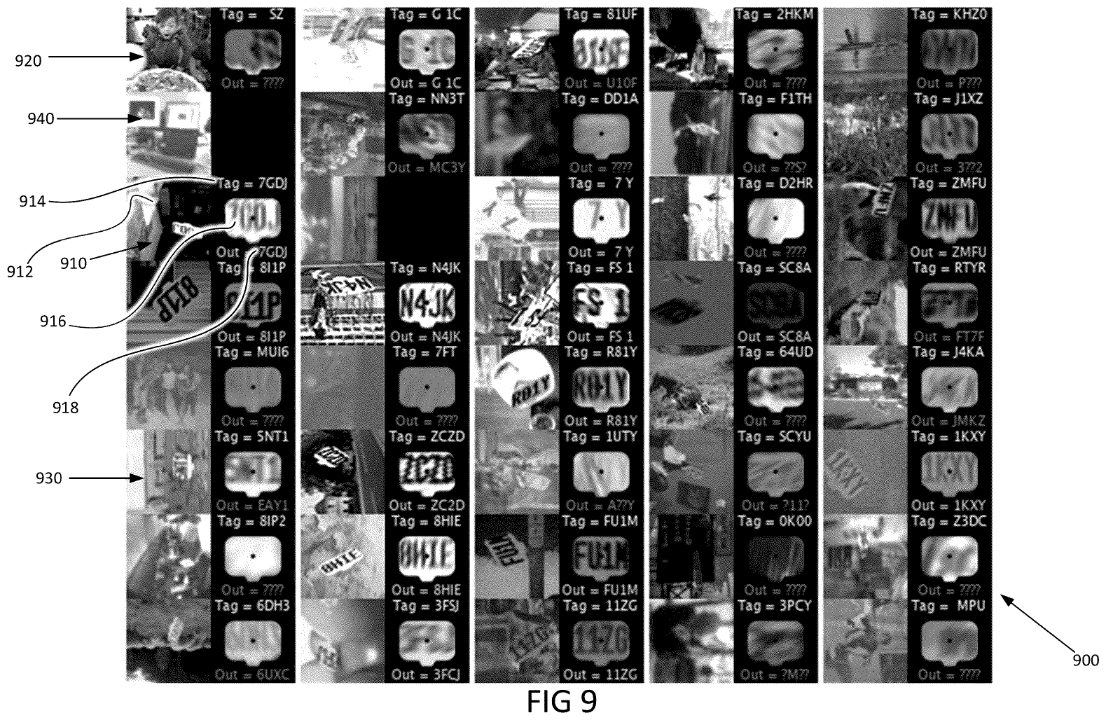

In a simulated output 900 using training data as shown in FIG. 9, a set of 4 types of identification are illustrated. The output type categories are a positive fiducial tag identification 910, an inconclusive identification 920, an erroneous identification 930, and a control 940. For each type of output category, such as for the positive identification 910, the randomly, automatically transformed fiducial tag superimposed on the randomly selected background image 912 is shown. The known set of characters 914 is displayed above the isolated fiducial tag 916. The isolated fiducial tag 916 is isolated from the image 912 and is shown to aid in error checking and verification of the output if necessary. The automatic, machine generated output from the DenseNet machine vision system is provided at 918. In the exemplary positive identification 910, the known tag characters 914 were “7GDJ”. The fiducial tag 916 was correctly identified and shown, and the output 918 of “7GDJ” was correctly identified. Correct output text may be shown in one color, such as green, and incorrect or inconclusive output text may be shown in another color, such as red. For inconclusive outputs 920, a set of questions marks “????” is used to identify inconclusive outputs. Erroneous outputs 930 may comprise one or more incorrect characters, such as shown in the example where the incorrect output was “EAY1” compared to the known input “SNT1”. Control outputs 940 show where a control image was correctly identified as comprising no fiducial tag superimposed on the background image and are used to verify the operation of the DenseNet.

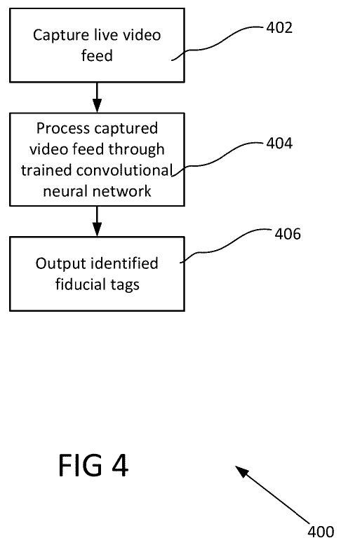

With reference now to FIGS. 4, 10, and 11, an embodiment of a system and method for implementing a convolutional neural network-based machine vision system trained by a set of simulated training data to identify fiducial tags associated with or disposed on entities from real-world images or video is provided.

FIG. 4 provides a flow chart of a process 400 for capturing real-world images or video of entities with associated fiducial tags and identifying the entities based upon fiducial tags identified by a machine vision system (e.g., the system 10 shown in FIG. 1 or the system 200 shown in FIG. 2). In step 402, real-world images or video, which may be live images or real-time (e.g., contemporaneous to the current time, such as within 10 minutes of the current time) images or video, are captured by one or more image sensors. For example, in one embodiment images or video of animals with fiducial tags (e.g., four-character HOGMAX tags) in an animal retaining space are captured. In step 404, the captured images are stored and/or processed. For example, the images may be stored on a networked video recorder for processing by a local or remote computer system implementing a convolutional neural network-based computer-vision system. The captured images may be processed by an image processing module and fed into a fiducial identification module and an entity identification module, wherein the fiducial identification module comprises a convolutional neural networked trained by a machine learning module implementing simulated training data. In step 406, the fiducial tags identified by the system are output, such as to a graphical user interface.

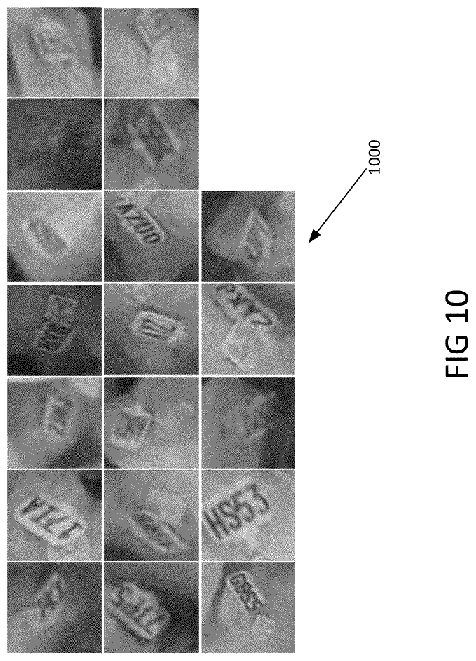

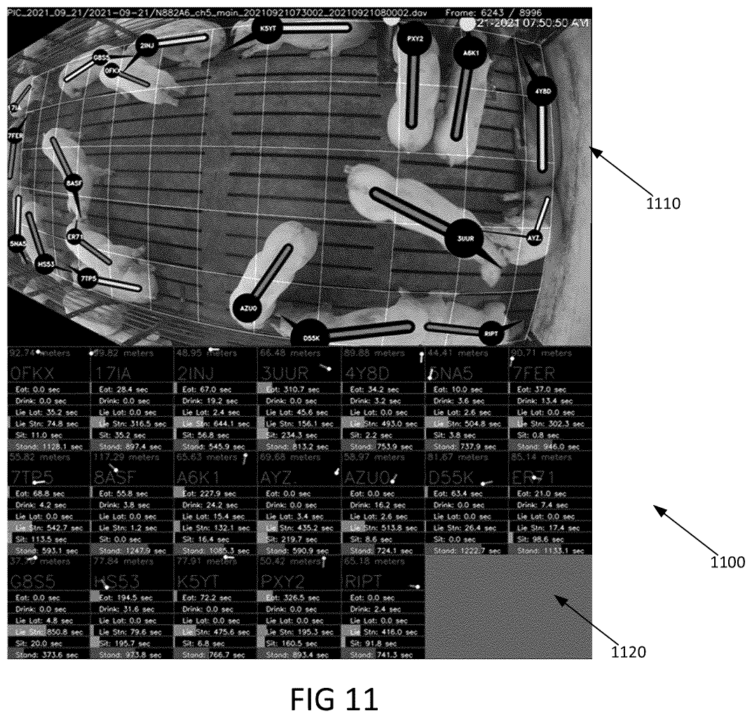

In one embodiment, the set of identified fiducial tags 1000, shown in FIG. 10 disposed on swine, are included as part of the output of step 406. The tags 1000 are actual fiducial tags disposed on animals in the real-world, and represent actual system output and not training data. An exemplary graphical user interface 1100, such as the one described in step 406, is provided in FIG. 11. The image 1110 illustrates a number of animals (swine) in an animal retaining space. An identified set of four characters that were identified from fiducial tags disposed on the animals is shown in black circles on each animal. A colored bar is shown along the back of each animal to indicate the location, position, orientation, and current action of each animal. For example, a red-colored bar may be used to indicate a standing animal, a teal-colored bar may be used to illustrate a prone animal, and a yellow-colored bar may be used to illustrate a sitting animal, but other colors and indicators may be used. The display area 1120 provides each identified individual in the image based on the identified fiducial tag. Confidence bars for a current action for each animal are shown, as well as estimated times for each activity, such as time eating, time drinking, time prone, time sitting, and time standing. The activity or action with the highest confidence is used to color-code the bar on the animal. For the behavior or activity determination shown in FIG. 11, a deep, fully-convolutional neural network is used to determine body position and ear (fiducial) tag location for each animal in the animal retaining space. In one embodiment, error control coding is used for the fiducial tags. For example, no two animals in the space have more than one character in common on the fiducial tags. This provides for the use of only a two-character correct read to identify any given animal in the space. However, in one embodiment, a minimum requirement of three correctly identified characters on any given fiducial tag may be required to avoid false-positive identifications. These methods may also be used for the identification of any other entity in any other context.

While the embodiments described hereinabove relate substantially to an implementation of a simulation and training process for training a deep, fully-convolutional neural network for the purpose of identifying four-character tags, or tags comprising a specific set of characters and specific number of characters, the simulation and training process for training a deep, fully-convolutional neural network and the trained deep, fully-convolutional neural network itself may also be applied to other tag, character and fiducial types.

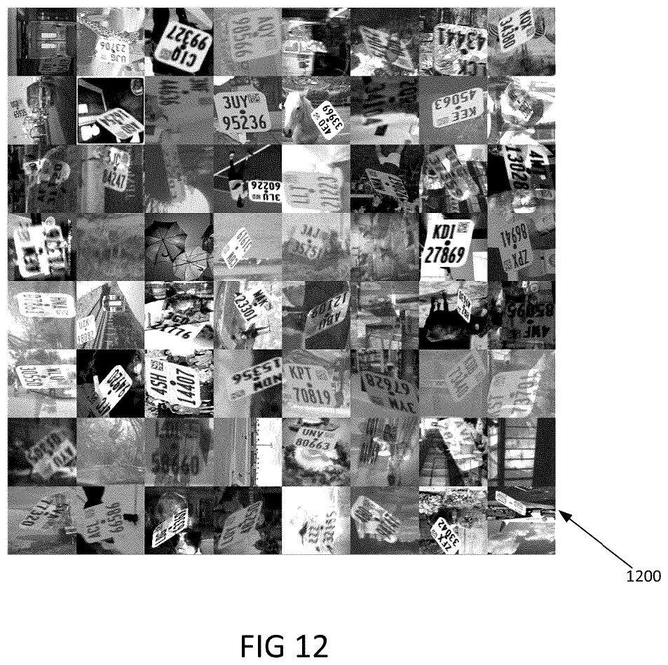

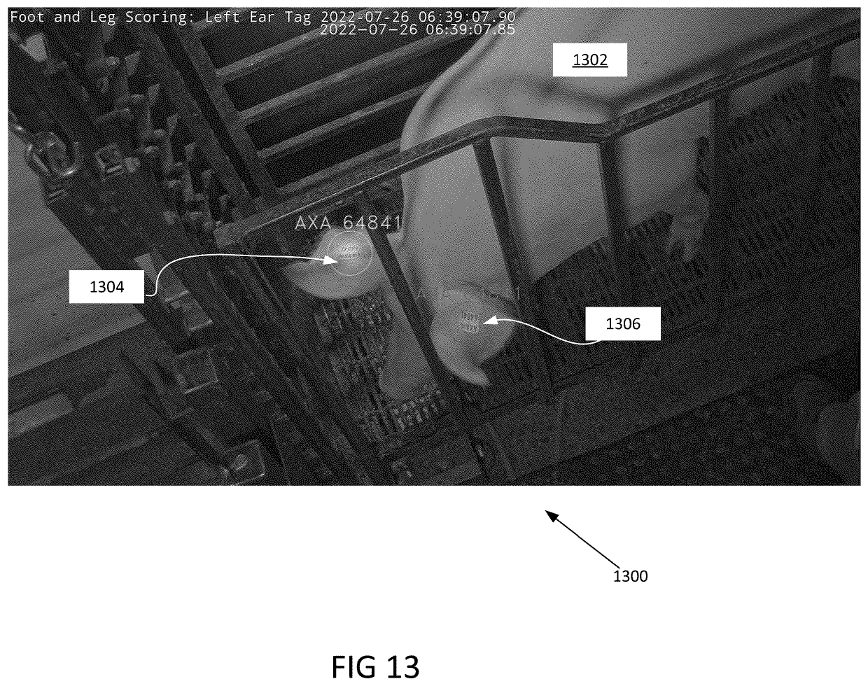

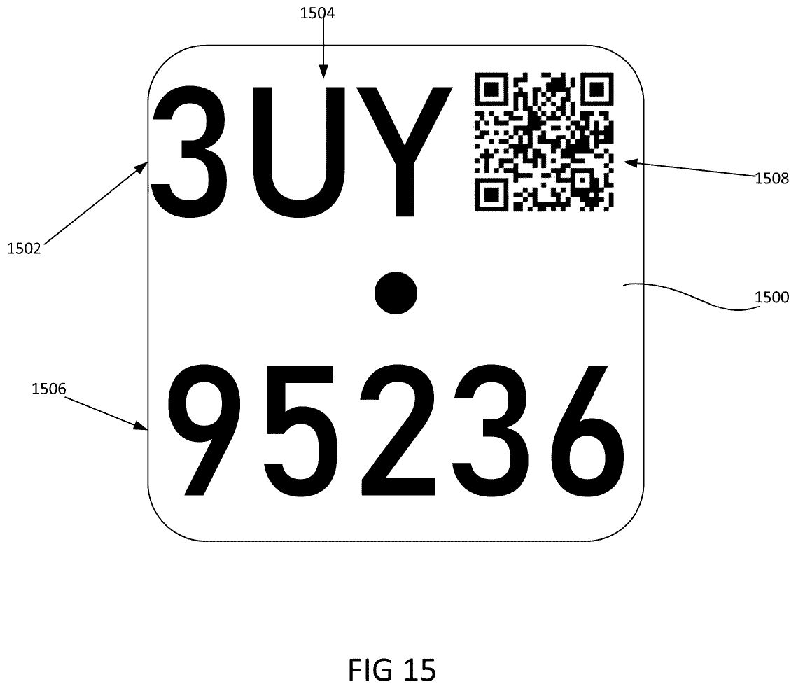

For example, as provided in FIGS. 12-14, the simulation and training process for training a deep, fully-convolutional neural network and the trained deep, fully-convolutional neural network itself has also been applied to LITTERMAX tags. LITTERMAX tags, such as the exemplary tag 1500 provided in FIG. 15, comprise an 8 character design, wherein of the 8 characters the first character (1502) identifies one of thirteen product lines, characters 2-3 (1504) may be any letter, and characters 4-8 (1506) may be any single digit integer. LITTERMAX tags further comprise a DATAMATRIX code (1508), which is a machine-readable type code (similar in nature to a QR code). As shown in FIG. 12, a set of simulated training images 1200 were generated by the system using simulated LITTERMAX tags superimposed on other images with varying types and degrees of obfuscation or manipulation applied to the images and tags. Actual LITTERMAX tag images may used in the superimposition in addition to or as a substitute for the use of simulated tags. The obfuscation and manipulation may be as described hereinabove with respect to FIG. 6 with the aim of creating a set of simulated images that provide simulacra of conditions that may be found with respect to real-world captured images of tags on entities (e.g., animals such as swine). Using a set of training images, such as those shown in FIG. 12, LITTERMAX tags were successfully identified and marked in a user interface as shown in FIG. 13.

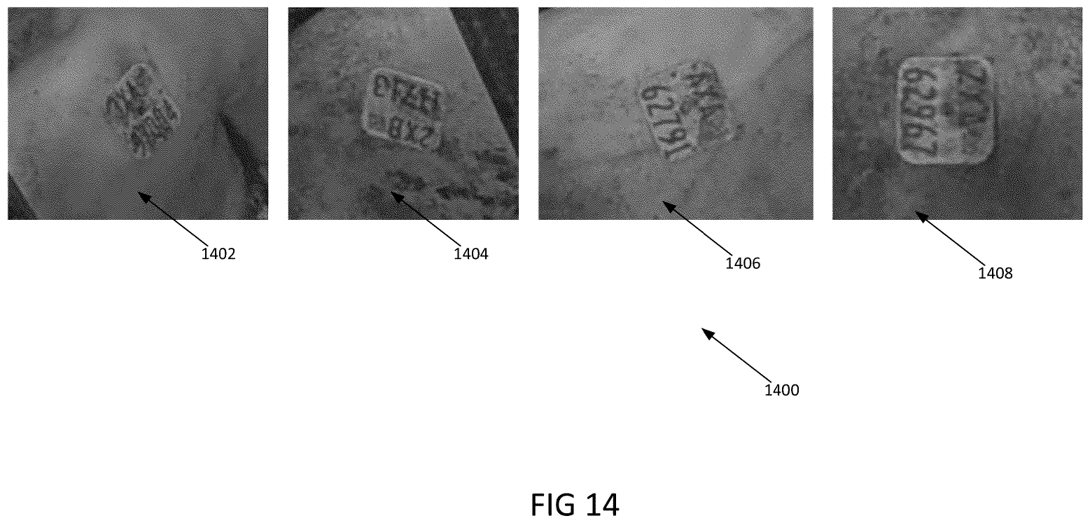

In the image 1300 in FIG. 13, animal 1302 is affixed with two identical LITTERMAX tags 1304 and 1306. The system implementing the deep, fully-convolutional neural network which was trained on simulated training images was able to correctly identify the tags 1304 and 1306 as comprising the characters AXA 64841. However, despite thorough and interactive training, sufficient obfuscation or blocking of characters on a tag presents challenges, and tags such as those shown in the set of images 1400 in FIG. 14 were not able to be correctly identified. In each of the images 1402, 1404, 1406, and 1408, factors such as angle, blurriness, dirtiness of the tag (such as by mud), etc. contributed to errors in tag identification. Additional human correcting and tagging, such as by manual marking of the characters in the image, of mis-identifications such as these may be used to manually feed in additional training data into the system to improve future identification. It should be noted, though, that the misidentifications comprised a small subset of the tags processed by the system. In an experimental implementation of the simulation and training process for training a deep, fully-convolutional neural network and the trained deep, fully-convolutional neural network itself as an ear-tag classification system resulted in the correct identification of 98% of ear tags from a set of more than 10,000 discrete animals and tags without any human intervention required. In the real-world conditions of the experiment, namely identifying LITTERMAX tags affixed to porcine sows, out of more than 10,000 tags processed fewer than 200 tags were mis-identified.

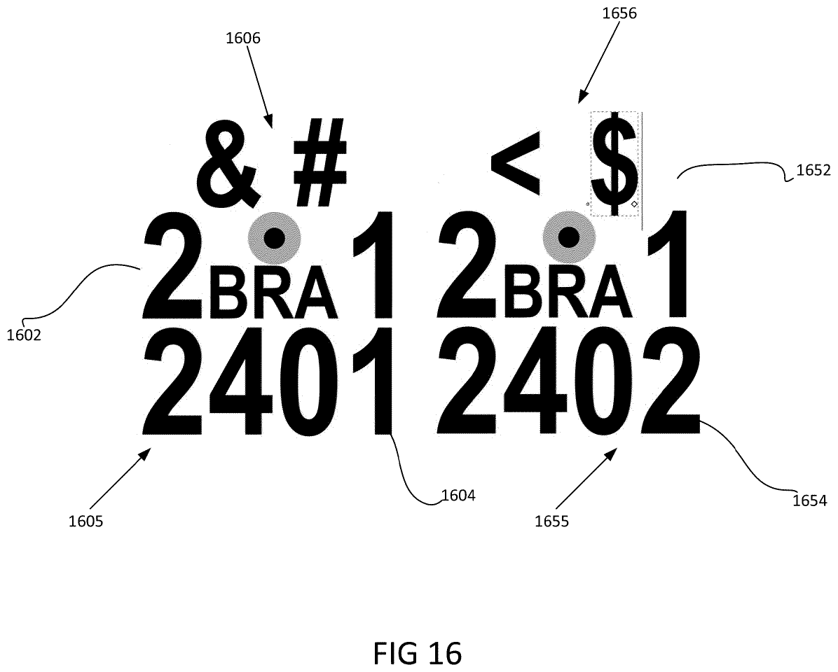

In addition to any of the tag types discussed hereinabove, additional features may be placed on the tags to improve the readability and identifiability of those tags by the machine vision system. For example, there may be a situation where two entities (i.e., animals) have tags affixed which share many characters or symbols in common. This may be a situation where a four-character tag shares three common characters at any location on the tag, and wherein the tags differ in only a single character. In this situation, distinguishing the tags and providing a high confidence in the identification of the individual characters or symbols on the tag is more difficult than in a situation where the tags differ by more than a single character. To address this issue, error correction fiducials, such as non-alphanumeric characters, may be used on the tag in addition to alphanumeric characters. As shown in FIG. 16, two tags 1602 and 1652 are provided. The two tags, apart from the error correction characters, differ in only a single character. Tag 1602 comprises a set of characters “2BRA12401” 1605 and tag 1652 comprises a set of characters “2BRA12402” 1655 which differ in only a single character where the last character 1604 of tag 1602 is “1” and the last character 1654 of tag 1652 is “2”. To aid in the proper identification of the characters and of the tags as a whole, each tag 1602 and 1652 comprises a set of error correction codes 1606 and 1656 respectively.

The codes 1606 and 1656 are error control coding. The error control coding is a set of additional symbols that are used to ensure correctness in the identification of the tag and characters or fiducials thereon. The error control coding is used to validate, with a high degree of probability, that the tag ID read by the computer vision system is correct. For example, the deep, fully-convolutional neural network described herein may be trained on an automatically generated training data set which comprises superimposed tags having error correction codes on top of or in other images and which are blurred or obfuscated to simulate real-world conditions.

In one embodiment, Reed-Solomon encoding is used to ensure that any two tags must differ by at least 1 character in addition to the number of symbols used. As provided in the example of FIG. 15, tag 1602 comprises the ID characters 1605 “2BRA12401” and the error correction code characters 1606 “& #”, and tag 1652 comprises the ID characters “2BRA12402” and the error correction code characters 1656 “<$”. Now, instead of the tags only being separated by a single character (1 vs 2 in the last of the ID characters), the tags are separated by three characters such that any single error can be detected and corrected. In another embodiment, the error correction codes may be used as a type of checksum to verify that the identification characters read and identified on the tag properly correspond to the expected value as provided in the checksum error correction characters.

In one embodiment, what is provided is a method of training a machine vision system comprising a convolutional neural network, the method comprising: generating or selecting a set of fiducial tags; generating a set of transformed fiducial tags by randomly transforming each fiducial tag from the set of fiducial tags; generating a set of superimposed training images by superimposing each transformed fiducial tag from the set of transformed fiducial tags on a random image from a set of images; and training the convolutional neural network by processing each superimposed training image in the set of superimposed training images.

In an embodiment of the method, the set of fiducial tags comprise four-character tags.

In an embodiment of the method, the convolutional neural network comprises a DenseNet convolutional neural network.

In an embodiment of the method, the DenseNet convolutional neural network comprises five Dense Blocks and one linearization block.

In an embodiment of the method, the linearization block comprises four convolutions used on a single feature volume to extract four probability vectors, one for each of the four characters of the fiducial tags.

In one embodiment, what is provided is a system for identifying a fiducial associated with an entity, the system comprising: a set of fiducial tags, each fiducial tag from the set of fiducial tags associated with an entity from a set of entities; an image sensor configured to digital capture images of the entity and the fiducial associated with the entity; and an application server in electronic communication with the image sensor, the application server comprising: a processor and a memory; a machine learning module; an image processing module; and a fiducial identification module.

In an embodiment of the system, the machine learning module comprises a set of code stored in the memory and when executed by the processor cause the machine learning module to: generate or select a set of simulated fiducial tags; generate a set of transformed fiducial tags by randomly transforming each fiducial tag from the set of simulated fiducial tags; generate a set of superimposed training images by superimposing each transformed fiducial tag from the set of transformed fiducial tags on a random image from a set of images; and train a convolutional neural network by processing each superimposed training image in the set of superimposed training images.

In an embodiment of the system, the fiducial identification module comprises a convolutional neural network configured to identify the set of fiducial tags associated with the set of entities.

In an embodiment of the system, the set of fiducial tags comprise four-character tags.

In an embodiment of the system, the convolutional neural network comprises a DenseNet convolutional neural network.

In an embodiment of the system, the DenseNet convolutional neural network comprises five Dense Blocks and one linearization block.

In an embodiment of the system, the linearization block comprises four convolutions used on a single feature volume to extract four probability vectors, one for each of the four characters of the fiducial tags.

In an embodiment of the system, the processor is a graphics processing unit.

In one embodiment, what is provided is a method of training a machine vision system comprising a convolutional neural network, the method comprising: generating or selecting a set of fiducial tags; generating a set of transformed fiducial tags by randomly transforming each fiducial tag from the set of fiducial tags; generating a set of superimposed training images by superimposing each transformed fiducial tag from the set of transformed fiducial tags on a random image from a set of images; and training the convolutional neural network by processing each superimposed training image in the set of superimposed training images.

In various embodiments, the set of fiducial tags comprise four-character tags, six-character tags, eight-character tags, or ten-character tags.

In various embodiments, a subset of characters on each of the set of fiducial tags comprises error-control coding.

In various embodiments, the error-control coding comprises Reed-Solomon encoding.

In various embodiments, the convolutional neural network comprises a DenseNet convolutional neural network.

In various embodiments, the DenseNet convolutional neural network comprises five Dense Blocks and one linearization block.

In various embodiments, the linearization block comprises four convolutions used on a single feature volume to extract four probability vectors, one for each of the four characters of the fiducial tags.

In various embodiments, training the convolutional neural network further comprises training the convolutional neural network to identify a set of characters on a physical tag.

In various embodiments, the method further comprises associating the set of characters on the physical tag with an entity.

In various embodiments, the entity is a porcine or bovine animal.

In one embodiment, what is provided is a system for identifying a fiducial associated with an entity, the system comprising: a set of fiducial tags, wherein each fiducial tag from the set of fiducial tags is associated with an entity from a set of entities: an image sensor configured to digital capture images of the entity and the fiducial associated with the entity; and an application server in electronic communication with the image sensor, the application server comprising: a processor and a memory; a machine learning module; an image processing module; and a fiducial identification module.

In various embodiments, the machine learning module comprises a set of code stored in the memory and when executed by the processor cause the machine learning module to: generate or select a set of simulated fiducial tags; generate a set of transformed fiducial tags by randomly transforming each fiducial tag from the set of simulated fiducial tags; generate a set of superimposed training images by superimposing each transformed fiducial tag from the set of transformed fiducial tags on a random image from a set of images; and train a convolutional neural network by processing each superimposed training image in the set of superimposed training images.

In various embodiments, the fiducial identification module comprises a convolutional neural network configured to identify the set of fiducial tags associated with the set of entities.

In various embodiments, the system further comprises: an entity identification module; and wherein the entity identification module comprises a set of code stored in the memory and when executed by the processor cause the entity identification module to: associate a set of characters on the fiducial tag with an entity.

In various embodiments, the entity is a porcine or bovine animal.

In various embodiments, the set of fiducial tags comprise four-character tags, six-character tags, eight-character tags, or ten-character tags.

In various embodiments, a subset of characters on each of the set of fiducial tags comprises error-control coding.

In various embodiments, the error-control coding comprises Reed-Solomon encoding.

In various embodiments, the convolutional neural network comprises a DenseNet convolutional neural network.

In various embodiments, the DenseNet convolutional neural network comprises five Dense Blocks and one linearization block.

In various embodiments, the linearization block comprises four convolutions used on a single feature volume to extract four probability vectors, one for each of the four characters of the fiducial tags.

In various embodiments, the processor is a graphics processing unit.

The system, in one embodiment, comprises an overhead security camera connected via power-over-ethernet (“PoE”) for power and data to a Network Video Recorder (“NVR”) co-located at the same site or location as the camera. The NVR receives the images captured and transmitted by the camera for storage and later processing. A server, such as an image processing server comprising a graphics processing unit (“GPU”), is connected to the NVR via a secure file transfer protocol (“SFTP”). The image processing server is configured to request, receive, and process video captured and recorded by the camera to extract weight information for individual pigs. An API such as those provided in MATLAB, TENSORFLOW, or PYTORCH, or similar API or software package or environment capable of implementing deep learning, computer vision, image processing, and parallel computing, may be used to implement a trained convolutional neural network for image processing.

While the invention has been described by reference to certain preferred embodiments, it should be understood that numerous changes could be made within the spirit and scope of the inventive concept described. Also, the systems and methods herein are not to be limited in scope by the specific embodiments described herein. It is fully contemplated that other various embodiments of and modifications to the systems and methods herein, in addition to those described herein, will become apparent to those of ordinary skill in the art from the foregoing description and accompanying drawings. Thus, such other embodiments and modifications are intended to fall within the scope of the following appended claims. Further, although the systems and methods herein have been described herein in the context of particular embodiments and implementations and applications and in particular environments, those of ordinary skill in the art will appreciate that their usefulness are not limited thereto and that the present invention can be beneficially applied in any number of ways and environments for any number of purposes. Accordingly, the claims set forth below should be construed in view of the full breadth and spirit of the systems and methods as disclosed herein.

What is claimed is:

1. A method of training a machine vision system comprising a convolutional neural network, the method comprising:
generating or selecting a set of fiducial tags;
generating a set of transformed fiducial tags by randomly transforming each fiducial tag from the set of fiducial tags;
generating a set of superimposed training images by superimposing each transformed fiducial tag from the set of transformed fiducial tags on a random image from a set of images; and
training the convolutional neural network by processing each superimposed training image in the set of superimposed training images.

2. The method of claim 1, wherein the set of fiducial tags comprise four-character tags, six-character tags, eight-character tags, or ten-character tags.

3. The method of claim 1, wherein a subset of characters on each of the set of fiducial tags comprises error-control coding.

4. The method of claim 3, wherein the error-control coding comprises Reed-Solomon encoding.

5. The method of claim 1, wherein the convolutional neural network comprises a DenseNet convolutional neural network.

6. The method of claim 5, wherein the DenseNet convolutional neural network comprises five Dense Blocks and one linearization block.

7. The method of claim 6, wherein the linearization block comprises four convolutions used on a single feature volume to extract four probability vectors, one for each of the four characters of the fiducial tags.

8. The method of claim 1, wherein training the convolutional neural network further comprises training the convolutional neural network to identify a set of characters on a physical tag.

9. The method of claim 8, further comprising associating the set of characters on the physical tag with an entity.

10. The method of claim 9, wherein the entity is a porcine or bovine animal.

11. A system for identifying a fiducial associated with an entity, the system comprising:
a set of fiducial tags, wherein each fiducial tag from the set of fiducial tags is associated with an entity from a set of entities;
an image sensor configured to digital capture images of the entity and the fiducial associated with the entity; and
an application server in electronic communication with the image sensor, the application server comprising:
a processor and a memory;
a machine learning module;
an image processing module; and
a fiducial identification module.

12. The system of claim 11, wherein the machine learning module comprises a set of code stored in the memory and when executed by the processor cause the machine learning module to:
generate or select a set of simulated fiducial tags;
generate a set of transformed fiducial tags by randomly transforming each fiducial tag from the set of simulated fiducial tags;
generate a set of superimposed training images by superimposing each transformed fiducial tag from the set of transformed fiducial tags on a random image from a set of images; and
train a convolutional neural network by processing each superimposed training image in the set of superimposed training images.

13. The system of claim 12, wherein the fiducial identification module comprises a convolutional neural network configured to identify the set of fiducial tags associated with the set of entities.

14. The system of claim 13, wherein the system further comprises
an entity identification module; and
wherein the entity identification module comprises a set of code stored in the memory and when executed by the processor cause the entity identification module to: associate a set of characters on the fiducial tag with an entity.

15. (canceled)

16. The system of claim 12, wherein the set of fiducial tags comprise four-character tags, six-character tags, eight-character tags, or ten-character tags.

17. The system of claim 12, wherein a subset of characters on each of the set of fiducial tags comprises error-control coding.

18. The system of claim 17, wherein the error-control coding comprises Reed-Solomon encoding.

19. The system of claim 13, wherein the convolutional neural network comprises a DenseNet convolutional neural network.

20. The system of claim 19, wherein the DenseNet convolutional neural network comprises five Dense Blocks and one linearization block.

21. The system of claim 20, wherein the linearization block comprises four convolutions used on a single feature volume to extract four probability vectors, one for each of the four characters of the fiducial tags.

22. (canceled)
